(19) United States
(12) Patent Application Publication
(10) Pub. No.: US 2018/0361179 A1
(43) Pub. Date: Dec. 20, 2018

(54) RESPIRATORY EQUIPMENT FOR AIRCRAFT, WITH INFLATABLE MASK AND HARNESS, AND ITS STORAGE SPACE

(71) Applicant: Zodiac Aerotechnics, Plaisir (FR)

(72) Inventors: Jean-Philippe Sibuet, Verneuil Sur Sein (FR); Olivier Potet, Ville Du Bois (FR)

(21) Appl. No.: 16/009,082

(22) Filed: Jun. 14, 2018

(30) Foreign Application Priority Data
Jun. 16, 2017 (FR) 1755521

(51) Int. Cl. A62B 25/00; A62B 18/08; A62B 7/14

(52) U.S. Cl. CPC A62B 25/005; B64D 2231/025; A62B 7/14; A62B 18/084

(57) ABSTRACT

Respiratory equipment for aircraft, comprising a respiratory mask with regulator, an inflatable harness configured for being connected to a pressurized gas source, and adjusted to keep the respiratory mask on the user, a flexible gas supply tube connected to the respiratory mask for supplying the respiratory mask from a breathing gas supply, a storage space comprising a housing suited to house the respiratory mask and the inflatable harness in a storage position wherein the respiratory equipment comprises an interface element connected to an inflatable harness, where the interface element is configured to engage with a pneumatic valve acting selectively on the breathable gas supply and configured for being detachably retained by at least one retention element and in which the interface element is movable between a test position in which the interface element is pushed by a force and the pneumatic valve causes an opening of the breathing gas supply towards the flexible tube and a normal storage position, obtained without force exerted, in which the pneumatic valve prevents the circulation of breathing gas.

### CROSS-REFERENCE TO RELATED APPLICATIONS

This application claims the benefit of and priority to French Patent Application No. 1755521, filed on Jun. 16, 2017, the entire contents of which application are hereby incorporated herein by this reference.

### FIELD OF THE INVENTION

The invention relates to respiratory equipment for providing breathing gas to an aircraft crewmember.

In particular the invention relates to respiratory equipment provided for use in particular by the pilot or copilot especially in case of cockpit depressurization above a certain altitude above which the oxygen concentration in the outside air is insufficient for the human body. The respiratory equipment can be worn preventively at some high altitudes or else in case smoke is present.

The invention also relates to a method characterizing the operation of the respiratory equipment in question and installation thereof on the face of the pilot or copilot.

### BACKGROUND OF THE INVENTION

Aircraft that fly above a certain altitude require either a cabin pressurization system as in the case of commercial airplanes, or a supply of breathing gas (notably oxygen) for crewmembers as in the case of unpressurized military or utility aircraft.

In both cases, specific respiratory equipment is provided at least for the pilot and for the copilot for providing a breathing gas through a respiratory mask to these people and more generally to any cockpit crew member.

The respiratory mask can be worn in preventive mode in an airline provided with pressurization but which flies at an altitude over 40,000 feet where preventive wear is recommended (or according to other conditional instructions), and finally the respiratory mask can be worn in the event-based mode following an incident with the aircraft pressurization system, or in case of smoke in the cockpit.

In the case of wearing in event-based mode, in case of a sudden depressurization incident in the cabin and/or cockpit, the pilot or copilot must be able to install the respiratory mask and breathe breathable gas within five seconds, and it must be possible to use one hand for said complete installation maneuver, the other hand being mobilized for other tasks, in particular piloting tasks for aircraft flight controls.

In other words, in case of depressurization, the user of the emergency equipment, which is typically the pilot or copilot, must very quickly get the respiratory mask which is located in a storage space within their immediate reach and next place it around their head in order to be able to breathe through the respiratory mask thus providing them breathing gas.

The respiratory mask with regulator includes a nose and mouth face piece, suited for application to the face of the crewmember, around the mouth and nose for delivering breathing gas, preferably on demand. The respiratory mask also comprises an inflatable harness. With this inflatable harness, the nose and mouth face piece can be kept on the face of the crewmember. The respiratory mask can further comprise a protective screen (integrated or as a separate part) that protects the user's eyes against possible flying/foreign objects and also in particular smoke.

Additionally, the procedures for verifying the proper operation of the equipment of the aircraft (“checklists”) pre-takeoff clearance include a procedure for verifying the availability and correct operation of equipment intended to provide breathing gas in case of need in the cockpit. This procedure, often called “press to test” includes a pressurization of the regulator mask and simultaneously setting a flow rate of the regulator.

This Press to test verification test typically uses at least one button that has to be used (for example, it needs to be pressed) and a visual flow rate control which shows the availability of an oxygen flow to the nose and mouth face piece during the test.

Additionally, in aircraft (airplanes and helicopters), storage space formed by a case in which the respiratory mask is stored when it is not in use, is not very large and the inflatable harness must be folded back on itself so that the mask and harness can be correctly returned together in this space.

When an emergency condition is detected, the user has less than five seconds to get the mask with one hand and position it on their face. It is therefore required that the harness be quickly and fully deployed when it is removed from its storage space.

In order to guarantee a proper deployment of the respiratory mask harness, it is also important that the respiratory mask can be stored appropriately in the storage space. This storage operation can be delicate and unintuitive. If the storage meets the recommendations, then deployment of the harness does not pose any problem, but if storage is incorrect, the later deployment of the harness can prove to take longer than expected.

It cannot be guaranteed that the storage always meets recommendations because this storage operation is done manually and therefore highly dependent on the human factor and training level given out by the airline companies and the maintenance documents made available to the operators.

A need therefore appeared for improving the solutions which allow both proceeding with the test of good oxygen operation before the flight departs and which allows assuring the deployment without hindrance of the harness when a crew member takes the respiratory mask out from the storage space in an emergency.

It will be noted that the person skilled in the art commonly designates the breathing gas mentioned in the present document as “oxygen.”

### BRIEF DESCRIPTION OF THE INVENTION

For this purpose, the invention relates to respiratory equipment for aircraft, comprising:
a respiratory mask with regulator suited for being applied, in a use position, around the users nose and mouth;
an inflatable harness configured for being connected to a pressurized gas source (this pressure source also most often serves for regulated respiration but it can be different), and adjusted to keep the respiratory mask on the user;
a flexible gas supply tube connected to the respiratory mask near a downstream end for supplying the respiratory mask from a breathing gas supply;
a storage space comprising a housing suited to house/store at least one respiratory mask and the inflatable harness in a storage position and having an access opening, where the respiratory mask is away from the housing in the use position,
   the respiratory equipment comprising an interface element connected to the inflatable harness, where the interface element is configured to engage with a pneumatic valve (V) acting selectively on the breathable gas supply upstream of the flexible tube and where the interface element is configured for being detachably retained by at least one retention element,
   and in which the interface element is movable, all while staying retained by the retention element, between a test position in which the interface element is pushed (or pulled) by a force exerted directly by a finger of the user and the pneumatic valve opens the breathing gas supply towards the flexible tube and a normal storage position, obtained without force exerted by the user, in which the pneumatic valve prevents the circulation of breathing gas.

Thanks to these dispositions, the engagement between the interface element connected to the inflatable harness and the pneumatic valve arranged on the gas supply serve to verify, with the oxygen availability test, during the pre-takeoff clearance procedure, that the interface element is in fact correctly positioned in the retaining element which renders more reliable a later step of removing the respiratory mask and deploying the harness reliable.

By means of which, the only possibility for correctly performing the required oxygen PTT test is to push(or pull) the interface element and positively observe a correct feedback, in particular via a visual feedback/indicator and an auditory feedback (oxygen flow and audio system); the interface element, in adequate position, will guarantee a later deployment of the harness under optimal conditions.

In various embodiments of the assembly according to the invention, one and/or another of the following provisions can additionally be used.

According to one configuration, when the interface element (4) is removed from a retention position (PR) where the interface element is normally held by a retention element (9) in the storage position (P2) or the rest position (P1), then the pneumatic valve causes an opening for passage from the pressurized gas source to the inflatable harness and/or secondarily causes an opening of the breathable gas supply to the flexible tube.

By means of which, the supply of pressurized gas for inflating the harness is only possible when the interface element detaches while the respiratory mask is already out of the housing and the harness is unfolded at least in part because of the retention provided by the interface element before it detaches. Thus, we avoid that a too premature inflation of the harness would interfere with and hinder its deployment if previously it had been folded in the visor/goggles or inside the joint of the nose and mouth mask.

According to the pneumatic configuration, the supply of breathable gas to the mask can also be conditioned on detachment of the interface element and the supply of breathable gas to the mask does not occur until the respiratory mask is already out of the housing and the harness is unfolded, but however the supply of breathable gas to the mask occurs before the user has really applied the mask to the face.

In other words, the supply of gas in the flexible tube is delayed for delaying the inflation of the harness even if the gripping ears of the regulator are already pushed by the user.

According to a configuration, the source of pressurized gas for the inflatable harness is formed by the supply of breathable gas brought by the flexible tube. There is therefore only one multifunction pneumatic conduit for breathing and harness inflation. Under these conditions, it is noted that detachment of the interface element causes the supply of gas to the mask (opening of the valve), supply of breathable gas to the regulator of the mask and, following activation of the gripping levers/ears, inflation of the harness.

According to a configuration, the pneumatic valve is part of a distributor connected to the gas supply tube and the interface element is configured for engaging with a piston of said distributor.

With the use of such a pneumatic distributor, both the oxygen Press-to-Test procedure and the delayed supply of breathable gas to the respiratory mask (for delayed inflation) can be managed.

According to another configuration, the pneumatic valve controls a distinct auxiliary distributor. The auxiliary distributor can be located remotely and connected to the pneumatic valve by a tube, or else the auxiliary distributor can be located near to the pneumatic valve.

According to a configuration, the interface element can comprise an area for engagement with the retention element, for example a snapping-together function, which provides a hold on the interface element so long as the pulling force remains below some threshold, and the interface element can comprise a shape for engagement with the piston of said distributor for maintaining the piston pushed against an elastic restoring element.

Thus, the interface element can be formed by a relatively simple part, preferably monolithic.

According to a configuration, the piston of the distributor is displaceable along a longitudinal axis between a first position called test position corresponding to the test position of the interface element (interface element pressed/pushed by a manual action against elastic restoration), a second position called closed-circuit corresponding to the normal storage position of the interface element (piston pushed back by the interface element, against elastic restoration), and a third position called established circuit corresponding to the lifted position of the interface element (normal supply). Preferably, the second position is located between the first and third positions.

Thanks to a series of toroidal seals arranged on the distributor piston, it is arranged such that the first position and the third position allow establishing a single open pneumatic system, whereas the second position establishes a closed pneumatic circuit.

According to a configuration, the piston of the distributor is displaceable along a longitudinal axis between a first position called test position (interface element pressed/pushed by manual action) corresponding to the test position of the interface element (PTT position), which also serves as established circuit position corresponding to a removed position of the interface element (normal supply), and the second position called closed-circuit, corresponding to the normal storage position of the interface element (piston pushback by the interface element against, against an elastic restoration).

With only two positions from the pneumatic perspective, the identity between the test position and the established circuit position increases the coverage rate of the Press-to-Test oxygen because the pneumatic system is found in exactly the same configuration.

According to a configuration, the position is biased at least towards the second position, either by an elastic element, or by the breathing gas pressure. Such a system has a simple assembly and such a passive restoration assures high reliability.

According to a configuration, the interface element, when it is in position in the retention element, is visible from outside of the storage space. The pilot or the copilot can thus visually verify the presence of the interface element which participates in the pre-flight test procedure.

According to a configuration, the interface element, when it is in position in the retention element, is accessible by one or more fingers of the user. The pilot and copilot can thus push the interface element for proceeding with the preflight test procedure.

According to a configuration, the respiratory equipment can further comprise at least one door mobile between a closed position in which it at least partially blocks the access opening and an open position in which it is clear of the access opening, and the interface element, when it is in position in the retention element, is accessible to a manual maneuver of the user from outside the storage area when the door is in closed position. The oxygen test can then be done in a normal storage position with closed door(s).

According to a configuration, the mechanical linkage between the retention element and the interface element is a ball joint linkage. The traction necessary to remove the interface element from the hold thereof in the retention element is homogeneous in an activation cone, at least for a predefined solid angle.

According to a configuration, the pneumatic distributor is located in the median zone of one of the housing walls, preferably lying further away in alignment with the position of the interface element when it is in position in the retention element. Thus, a simple assembly and ease of integration in the storage box is obtained.

According to a configuration, the interface element is connected unremovably/undetachably on the back bottom part of the harness, preferably by means of a short, flexible link. The interface element and the flexible link are embedded with the harness but are not substantially bothersome for the user or the crewmember using the respiratory mask.

According to a configuration, the length of the flexible link is under/below 10 cm, preferably under 7 cm and even more preferably under 5 cm.

The retention element can be attached in the housing. Thus a simple and reliable mechanical mounting is obtained.

The pneumatic valve (V) can be arranged in the housing.

In this configuration note that the pneumatic valve is not on the mask, it is not outside the housing either.

### BRIEF DESCRIPTION OF THE DRAWINGS

Other characteristics and advantages of the present invention will appear in the following detailed description, with reference to the attached drawings in which:

FIG. 1 is an overall view of a storage space comprising the respiratory mask and the inflatable harness according to a first embodiment;

FIG. 1B shows an overall perspective view of the respiratory mask removed from the housing;

FIG. 2 is an overall view of the respiratory mask and the inflatable harness in a position for use on a crew member;

FIGS. 3A, 3B and 3C schematically show a pneumatic distributor, an interface element and a retention element conforming to the first embodiment;

FIG. 4 shows the respiratory equipment in its stored state in the storage space;

FIG. 5 shows the respiratory equipment being deployed just before use thereof;

FIGS. 6A, 6B and 6C schematically show, analogously to FIG. 3A-3C, a second embodiment;

FIGS. 7A, 7B and 7C schematically show, analogously to FIG. 3A-3C, a third embodiment;

FIG. 8 shows a timeline which shows the delay resulting from inflating the harness.

### DETAILED DESCRIPTION OF THE INVENTION

In the various figures, the same references designate identical or similar items. For reasons of clarity of the disclosure, some elements are not necessarily shown to scale.

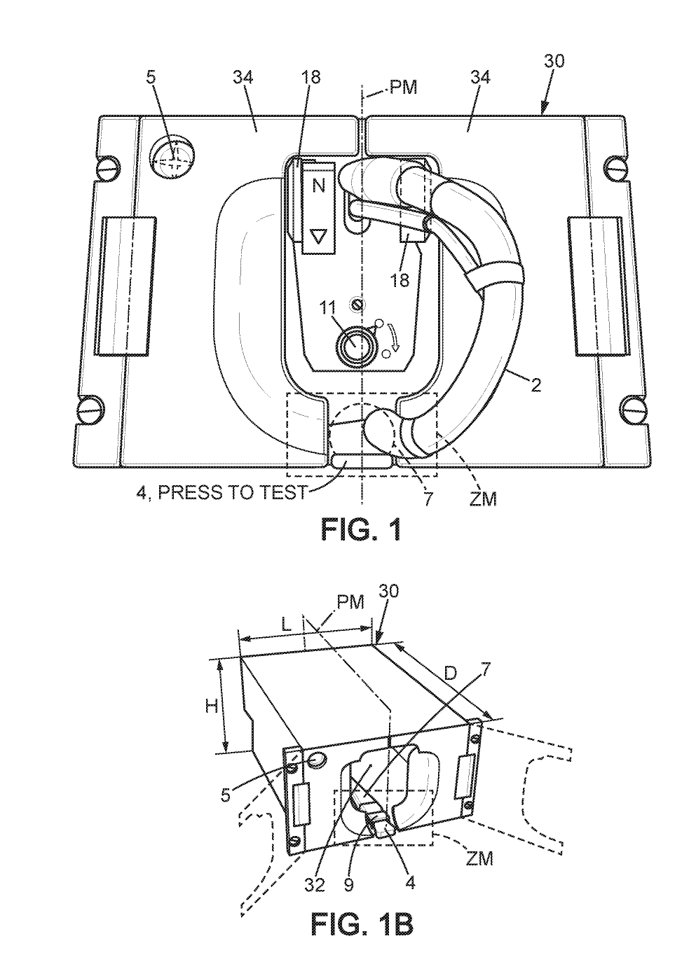

FIG. 1 shows an overall view of the storage space 30 containing a respiratory mask 10 and the inflatable harness 20 thereof; these components together form respiratory equipment 1 for aircraft.

In the example shown, the storage space 30 is a substantially parallelepiped box whose dimensions are constrained by something like a standard.

The storage space 30 can have the following dimensions: the width L can be comprised between 150 mm and 200 mm; the height H can be comprised between 100 mm and 150 mm; the depth D can be comprised between 200 mm and 280 mm. A particular example among others can be: width=170 mm, height=122 mm and depth=220 mm.

In the example shown, there are two doors 34 closing access to a housing 32 in which the respiratory mask and the inflatable harness thereof are stored. A median plane MP separates the left and right parts of the housing.

The doors protect the respiratory mask in stored position; however note that the presence of doors is not essential, the storage space will not have doors in some configurations. It can involve a mask receiving cup, called “cup” in the art.

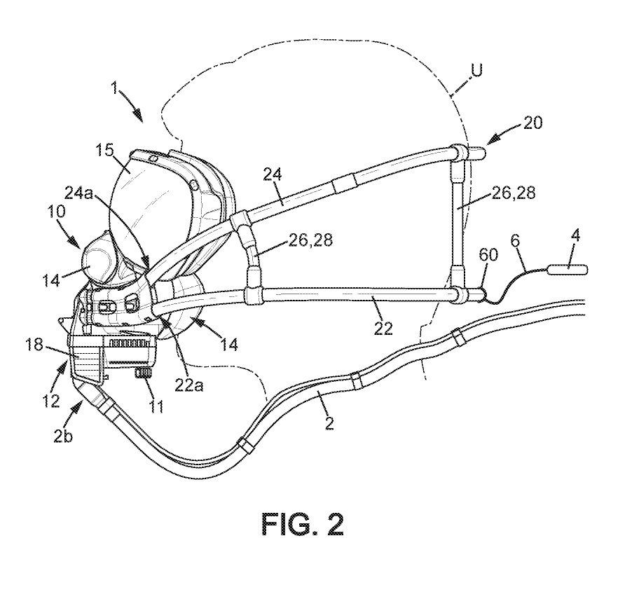

As shown in FIGS. 2, 4 and 5, the respiratory mask 10 comprises a regulator block 12 and a nose and mouth face piece 14 rigidly connected with the regulator block 12.

The respiratory mask 10 can also comprise a protective screen 15 (likewise called visor or airtight goggles), integrated or as a distinct, supplemental part. The protective screen 15 protects the user's eyes against the presence of smoke.

The nose and mouth face piece 14 can be any type known under the description “fullface” with integrated and inseparable protective screen.

The regulator block 12 is equipped with interfaces for pneumatic connections which will be given in detail later.

‘Breathable gas’ is understood to mean a gas or gas mixture comprising sufficient oxygen for avoiding a state of hypoxia of the user.

A flexible pneumatic tube 2 connects the regulator block to a source of breathable gas 3 via equipment of tap/valve/manifold type which will be given in detail later. More precisely, a first end 2a of the flexible tube is fixed to a pneumatic tap/valve/manifold arranged inside or near the storage space 30 and a second end 2b fluidly connected to the regulator block 12. The regulator block connects the flexible tube 2 (i.e. a fluid connection) with the demand regulator itself.

The inflatable harness 20 comprises straps 22, 24 intended for applying the mask and the face piece 14 thereof against the face and are connected to the regulator block 12. The regulator block 12 contains a demand regulator which delivers diluted or pure oxygen according to an “on-demand” mode controlled for example by the pressure decay generated by the breathing of the user U.

The regulator block could comprise a microphone for the audio communication function. It should be noted that in this case the flexible tube 2 can be accompanied by electrical conductors contributing to the audio and radio communication function. There can be a selection or adjustment button 11 on the regulator block, as is well known.

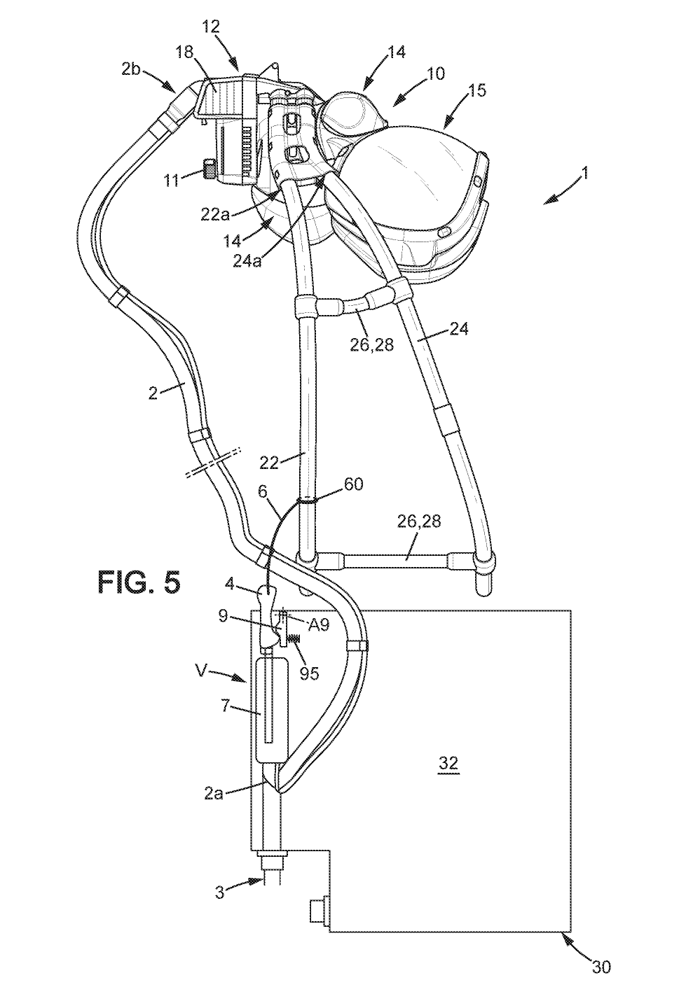

The harness 20 comprises a tubular elastic arrangement. The tubular elastic arrangement forms at least one loop adapted for extending around the head of a user, according to the circumference thereof. In the embodiment shown in FIGS. 2 and 5, the harness 20 forms two loops 22, 24. The two loops 22, 24 are kept spaced by flexible spacing elements 26, 28. The flexible elements 26, 28 extend transversely between the two loops 22, 24. In other words, the flexible elements 26, 28 extend vertically overall when the respiratory mask 10 is in condition for use (FIG. 2).

The principle of such an inflatable harness has been known for a long time; it is illustrated for example in the documents U.S. Pat. No. 3,599,636 or EP 0,288,391.

For example, each of the straps 22, 24 is made up of an inner tube of elastic material contained in an inextensible sleeve limiting the lengthening of the tube. The resting length of the inner tubes is such that they tend to apply the face piece 14 onto the face with sufficient pressure for providing the required tightness, whatever the outside pressure.

But the invention would also be applicable to harness comprising one or more inextensible bands and a deformation system to allow easy passage of the head.

The regulator block 12 is provided with a connection tip for the flexible conduit 2 for bringing pressurized breathing gas, and one or two connection tips 22a, 24a for extensible tubes for the straps.

Also, the regulator block comprises means for manual control of inflation of the harness made up by an inner valve (not shown in the figures) arranged in the regulator block 12 intended to be actuated by manual pinching of two ears 18, of which at least one is swinging, for example between the thumb and index finger of the user.

When the two ears 18 are not pinched, the tap is at rest, it connects an interior volume of the regulator block with the atmosphere, it allows the harness straps to retract/tighten (and to squeeze the head of the user if the harness is on the head).

Inversely, when the tap is actuated (meaning when the user pinches the ears 18), the harness straps allow pressurized gas coming from the supply tube 2 into the inner volume and the harness expands allowing it to be placed around the head or respectively to remove it, both easily even when the user wears glasses and/or earrings.

Advantageously according to the present invention, an interface element 4 connected to the inflatable harness 20 is intended.

In the context of the present document, the interface element 4 can also be called “clip.”

In the example shown, the mechanical connection between the inflatable hardness and the interface element 4 is made by means of a short and flexible link 6. Just the same, in other variants, the link could be semirigid or even absent (direct connection without flexible link).

The length of the link 6 is under 10 cm, preferably under 7 cm and even more preferably under 5 cm.

The link 6 is not substantially extensible; the length thereof varies little even under normal traction for detaching the interface element 4.

In a particular and advantageous configuration, the flexible link 6 is attached to the inflatable harness by a lower, back part, specifically a medial area of the lower strap 22 (see FIG. 2). The flexible link can be fixed to the lower tube either by a rigid clip 60 or by a sewn closed loop, or by any other undetachable means.

The interface element 4 can be found in at least three different functional configurations. One of the configurations was already set out above, it involves the situation where the inflatable harnesses on the head of the user and therefore the interface element 4 is suspended at the free end of the flexible link 6 without particular function in this area; it is however anticipated that the presence of this interface element is not too bothersome for the back of the head or neck of the user.

In two other configurations of interests, the interface element 4 is a prisoner of a retention element 9 arranged in the storage space, in a retention position noted PR.

More precisely, as shown in FIG. 1, the interface element 4 is arranged on the façade, in the lower part between the two doors, in an area noted ZM on the figures. The interface element 4 is available, in visual and tactile access, for a member of the crew to push it in order to do a test of oxygen availability called “Press to Test.”

This test consists of circulating oxygen (from the breathable gas) to the regulator block, by pushing on a test button laid out on the regulator block, to materialize the noise produced by the oxygen flow at the mask.

A visual feedback/indicator 5 of the proper operation involved in the oxygen availability test is provided; this visual feedback/indicator can be located on the front surface of the storage space, if need be on a door. According to an implementation example, a slit diaphragm is used which opens under the effect of the passage of gas and causes a visual contrast.

As will be seen later, the interface element 4 is used not only as an essential element for being able to proceed with the oxygen availability test, but also for contributing to the correct deployment of the inflatable harness when the mask and harness must be taken out of the storage space.

In the respiratory equipment, the interface element 4 is configured for engaging with a pneumatic valve V acting selectively on the breathable gas supply upstream from the flexible tube 2.

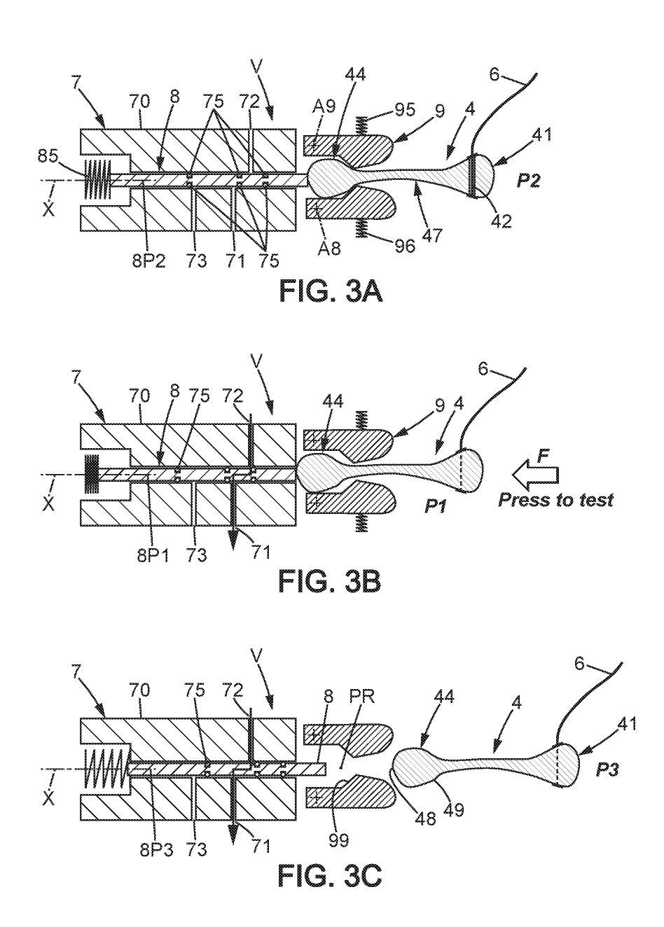

The interface element 4 is movable, while also staying retained by the retention element 9 between first a normal storage position (FIG. 3A, P2), obtained in the absence of force exerted by the user, in which the pneumatic valve blocks the circulation of breathing gas to the flexible tube 2 and second a test position (FIG. 3B, P1) in which the interface element 4 is pushed by a force F exerted directly by a finger of the user and the pneumatic valve V causes an opening of the supply of breathing gas to the flexible tube.

According to the first embodiment (FIG. 3A-3C), the pneumatic valve (noted generically V) is formed as a pneumatic distributor 7.

The distributor 7 comprises a body 70, a piston 8 (plunger), and ports 71, 72 and 73. One port 71 is connected to the breathable gas tube 2 towards the mask. Another port 72 is connected to the breathable gas supply source; the third port 73 is connected to free air (for allowing to purge the content of the flexible tube 2 before or during storage of the mask in the housing).

The interface element 4 engages mechanically with the piston 8, which can be moved along the axis X.

The position P1 of the interface element corresponds to the position 8P1 of the piston; the position P2 of the interface element corresponds to the position 8P2 of the piston; and the position P3 of the interface element corresponds to the position 8P3 of the piston.

O-rings 75, arranged in the grooves of the piston 8 and moved with the piston, are interposed without play between the body 70 of the distributor and the piston 8. These O-rings, with the passage generally left between the position of the body, selectively define, according to the position of the piston 8 and through the ports (71, 72, 73), a selective pneumatic circuit between the breathable gas source 3 and the flexible tube 2 as shown by the arrowed path in FIGS. 3A to 3C, 6A to 6C and 7A to 7C.

The piston 8 is returned, against the action exerted by the interface element 4, by a spring 85, which can be a conventional spring as shown schematically in the figures or else a pneumatic spring using pressurized gas, for example breathable gas or another source.

Note that the oxygen availability tests cannot be done if the interface element 4 is not present in the retention position PR thereof. Thus, the flight takeoff clearance can only be obtained if the interface element is in fact adequately positioned, which serves to guarantee an optimal deployment of the inflatable harness in case of need.

The interface element 4 is seen in the example shown as a molded plastic part which comprises a head 44, a trunk 47 and a larger holding area 41 (the holding area 41 can be called the “tail” of the interface element 4).

The head comprises a frontal shape 48 configured for pushing the piston, the head comprises a rear part 49 whose shape allows a retention in the retention element 9.

A ramp 99 can be provided on the retention element 9 for adjusting the force for escape of the interface element 4.

The holding area of 41 in the example shown comprises a through hole 42 through which an element can be passed for attaching the flexible link 6; according to an example, it is the flexible link which passes through the orifice and which is immobilized there by a stop element for each of the sides; of course other solutions are possible for attaching the flexible link 6 on the holding area on the trunk of the interface element 4.

The holding area 41 can have a general flat and wide area which turns out to be practical for being able to grasp the interface element between the thumb and index finger of the user.

Concerning the retention element, in the example shown, there are two retention elements 9A and 9B arranged symmetrically on either side of the interface element when it is in the retention position PR thereof (see FIGS. 3A and 3B).

Each retention element is mounted rotating around an axis A8, A9 with restoring spring(s) 95, 96 intended to create a threshold below which the interface element is retained and beyond of which it can be detached, meaning removed from the retention space PR.

When the user U grabs the mask to put it on their face, at the beginning of the movement, the interface element 4 is still in the retention position, and the pressurized gas supply in the flexible tube is not yet established. In that way, during the beginning of the maneuver, the inflatable harness remains deflated (even if the ears 18 are in fact pinched) which makes extraction of the assembly [mask+harness] from the housing easier. Further, the flexible link 6 which connects the lower strap 22 to the interface element 4 trapped by the retention element 9 naturally generates the deployment of the harness when the user pulls the regulator block upward, because the back part of the harness remains hooked. Beyond some force, the interface element detaches from the retention element and it is only at this time that the pressurized gas supply is established in the flexible tube to the regulator block. That is the way in which inflation of the harness is deferred until the time when it is already naturally deployed by the retention of the clip. The delay caused is not however a problem for the oxygen supply in the nose and mouth face mask 14; because of the short length of the link 6, the clip detaches well before the face piece can reach the face of the user U.

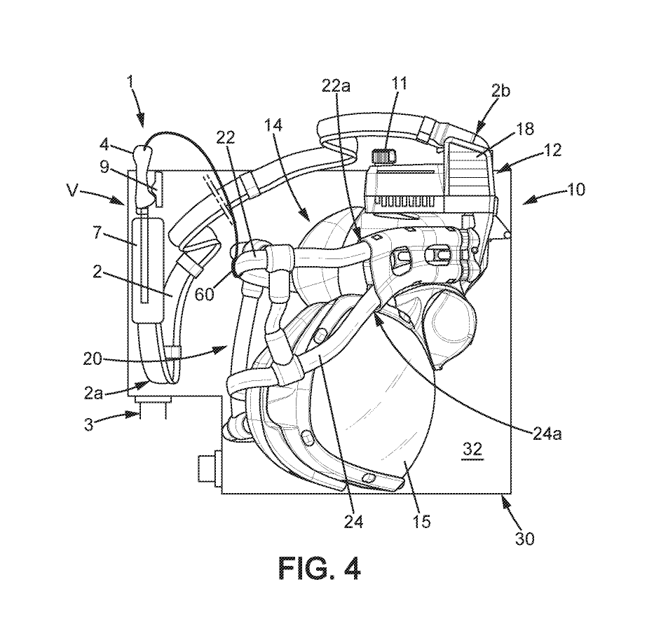

Note that there could be a single retention element 9 as shown schematically in FIGS. 4 and 5 and not two retention elements as in the cases shown in FIGS. 3A-3C, 6A-6C and 7A-7C.

Generally, it is planned that the force for extraction of the mask from the housing is preferably included between 10 N and 50 N, even between 20 N and 40 N.

The complementary shapes of the interface element 4 and the retention element 9 are designed to provide a force for release of the interface element 4 and therefore allow the complete release of the mask from the housing preferably included between 10 N and 50 N.

Concerning the force for release of the interface element 4 compared to the retention element 9, the interface shapes between these two parts comprise both a ramp 99 in the retention element 9 and also the rear part 49 of the head in the interface element 4 which together by engagement provide a snapping-together function because of the movement possible with elastic restoring from the retention element 9 (or retention elements).

Optionally it can be planned that this retention/snapping-together function could have a ball joint function, at least on a preset minimum solid angle. Thus, even if the traction is not exerted strictly along the axis, the release force would not be substantially changed by being off axis.

The shapes of the areas 49, 99 can be designed for getting a conical release area with homogeneous effort centered on the X axis with an opening for example greater than 30° (or else over a solid angle of order 0.5 steradians).

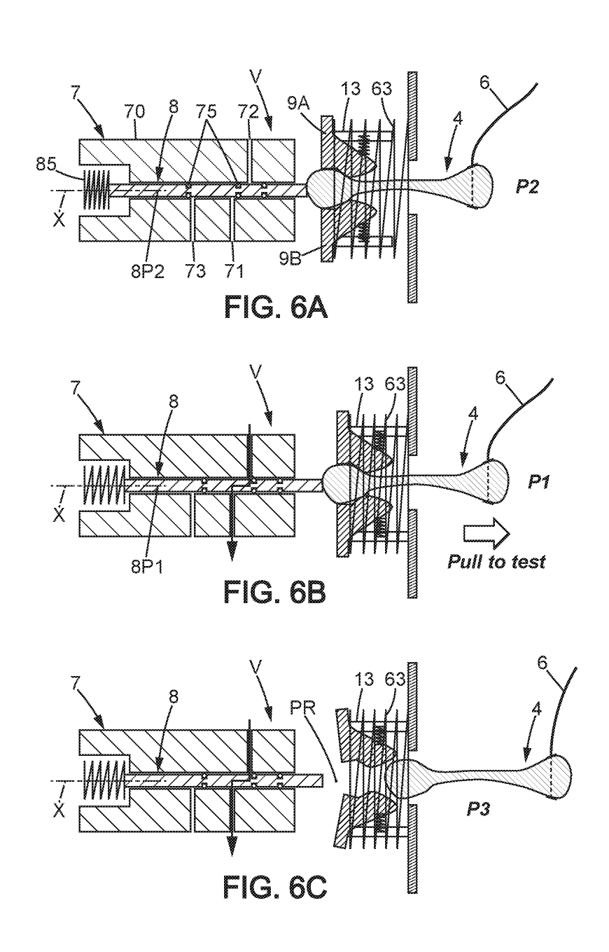

On FIGS. 6A, 6B and 6C which show a second embodiment, the retention elements bear on a mobile drawer 13 which provides a course between the test position P1 and the normal position P2. The mobile drawer 13 is mounted sliding along the X-axis with elastic recall exerted by a large spiral spring 63. The mobile drawer 13 provides an available course between the normal storage position P2 and the test position P1 which is reached by exerting traction on the interface element 4 (it involves a Pull to Test configuration, similar to the Press-to-Test configuration already described), specifically to the right on the figure, while the spring 63 pushes the drawer 13 back towards the left.

Beyond this force, the mobile drawer 13 having arrived at a stop, the interface element 4 then escapes from the retention elements 9 (respectively 9A, 9B) and allows inflation of the harness so long as the ears 18 are pushed by the user U.

Note that the elements not described again here are considered identical or similar to those from the first embodiment.

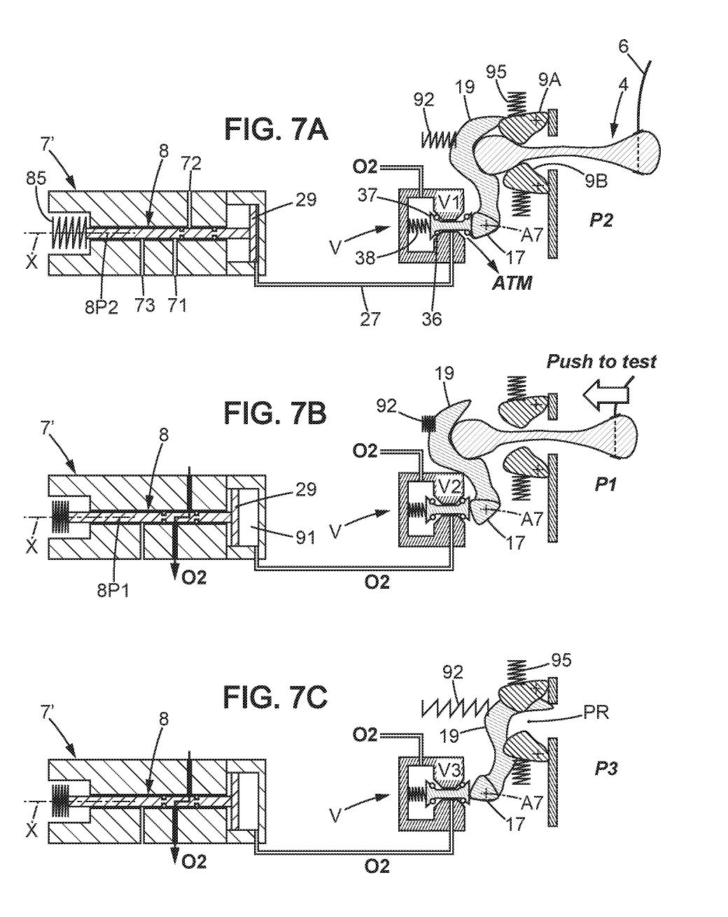

On FIGS. 7A, 7B and 7C which show a third embodiment, the pneumatic valve V controlled by the various positions in the interface element 4 does not directly control opening of breathable gas to the flexible tube—the pneumatic valve serves simply as a sensor; in fact, here a control tube 27 connects the pneumatic valve to an auxiliary distributor 7′ which can be arranged at some distance; this auxiliary distributor 7′ operates similarly to what was presented for the distributor from the first embodiment above, specifically it selectively commands the passage of breathable gas towards the flexible tube.

In this configuration, the interface element 4 is associated with a swinging lever 19 forming a cam control. The cam is referenced 17; this cam acts on a pneumatic selector comprising a piston 37 movable between two positions and O-rings 36 for sealing, preferably arranged on the conical parts. An intermediate pneumatic conduit marked 27 connects the pneumatic valve V (here for selection) to a pneumatic chamber 91 for control of an auxiliary distributor 7′ which plays the role of the main distributor as described in the second embodiment with only two pistons. In the auxiliary distributor 7′, a control piston 29 delimits the pneumatic control chamber 91.

In the example shown, the cam 17 pushes the piston 37 to the left then a restoring spring noted 38 pushes the piston 37 towards the right. The cam 17 and the lever 19 are rigidly connected and are rotationally mobile around the axis marked A7. The lever is restored in the clockwise direction by restoring spring 92, against the action of the interface element 4 whose head 44 is received in a convex portion of the lever.

In the position P2, the spring 38 pushes directly on the piston, the intermediate conduit 27 is emptied to the atmosphere ATM, the piston 8 of the main distributor is oriented straight and the flexible tube 2 is connected to free air. Inversely, in the two other positions P1 and P3, meaning the test position and the supply position when using the mask, the piston 37 of the selection valve is moved to the left, which causes pressurization of the intermediate conduit 27 and the pressurization of the pneumatic chamber 91 and consequently displacement to the left of the piston 8 of the main distributor 7′. This causes the supply of oxygen into the flexible tube 2.

Note that in this third embodiment, it involves a “Push a Test” configuration as in the first embodiment. However the distributor 7′ can be disposed in an arbitrary area and in particular elsewhere than in the extension of the interface element. Thus the distributor 7′ can be located in the housing 32 or out of it.

Similarly, note that having the retention element arranged near the housing would not be excluded; in the example shown, the retention element 9 is arranged in the housing 32 just like the valve V.

Note that in the first two embodiments, the pneumatic distributor is located in the median area ZM of one of the housing walls (here the one shown in the bottom), in the extension of the position of the interface element 4 when it is in position in the retention element; however the interface element and the distributor could be located in another position or inside the housing, for example on one side, in a corner, especially if the housing does not have door(s).

Note that the main distributor can be arranged in the storage box 30 or outside thereof. Also, the visual feedback/indicator 5 of oxygen flow can be arranged on the storage box, or, of course, one of the doors thereof, or even placed remotely. The visual feedback/indicator can be a light or a flow-reactive device.

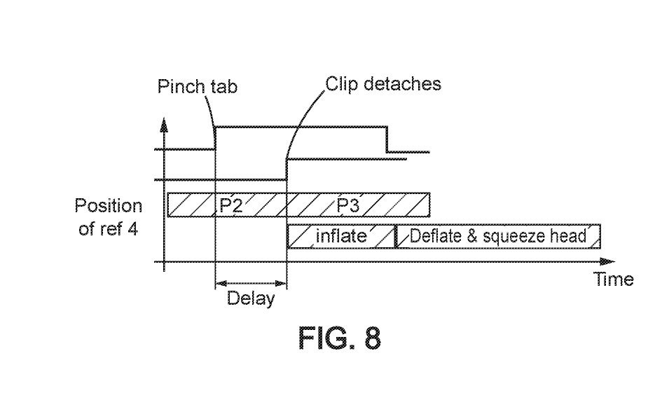

The timeline from FIG. 8 shows the delay obtained in inflation of the harness; in fact, when the user grasps the mask and pinches the ears 18, the harness does not yet inflate because the gas circuit is not yet established; it is only during the movement for deployment that the traction on the flexible link 6 leads to the release of the interface element 4 and the supply of gas. Then only at that time does the harness inflate (under good conditions, without tangling) and allows the passage of the head into the harness (i.e. placement of the harness on the head). When the user releases the ears, the harness retracts onto the head (see FIG. 2).

Note that in the configuration shown, the entire pneumatic system for breathable gas supply does not make use of any electrical element which could fail in case of an incident in the aircraft electrical system. Thus advantageously, oxygen availability does not have any dependence on aircraft electrical functions.

It needs to be noted here that the examples were given with a pressurized gas supply which serves both as vector for inflation of the inflatable harness and gas breathable by the user of the mask.

However, it could be different; there could be one conduit for breathable gas supply and another conduit for pressurized gas, not necessarily breathable, for the inflation function of the inflatable harness. For this purpose, in the independent claim “pressurized gas source” is understood to mean a gas with which to inflate the inflatable harness and then “breathing gas supply” means the breathing gas supply comprising oxygen intended for the lungs of the user U.

1. A respiratory equipment for aircraft, comprising:
a respiratory mask with regulator suited for being applied, in a use position, around the users nose and mouth;
an inflatable harness configured for being connected to a pressurized gas source, and adjusted to keep the respiratory mask on the user;
a flexible gas supply tube connected to the respiratory mask near a downstream end for supplying the respiratory mask from a breathing gas supply;
a storage space comprising a housing suited to house at least one respiratory mask and the inflatable harness in a storage position and having an access opening, where the respiratory mask is away from the housing in the position for use;
wherein the respiratory equipment comprises an interface element connected to an inflatable harness, where the interface element is configured to engage with a pneumatic valve acting selectively on the breathable gas supply upstream of the flexible tube and where the interface element is configured for being detachably retained by at least one retention element;
and in which the interface element is movable, all while staying retained by the retention element, between a test position in which the interface element is pushed by a force exerted directly by a finger of the user and the pneumatic valve causes an opening of the breathing gas supply towards the flexible tube and a normal storage position, obtained without force exerted by the user, in which the pneumatic valve prevents the circulation of breathing gas.

2. The respiratory equipment according to claim 1, wherein a mechanical connection is provided for connecting the inflatable harness to the interface element.

3. The respiratory equipment according to claim 2, wherein said mechanical connection is formed by a flexible link, preferably not detachable.

4. The respiratory equipment according to claim 3, wherein the flexible link is perhaps fixed to the inflatable harness either by a rigid clip or by a sewn closed loop.

5. The respiratory equipment according to claim 1, wherein the interface element is removed from a retention position where the interface element is normally held by a retention element in the storage position or the rest position, then the pneumatic valve causes an opening for passage from the pressurized gas source to the inflatable harness and/or causes an opening of the breathable gas supply to the flexible tube.

6. The respiratory equipment according to claim 1, wherein the source of pressurized gas for the inflatable harness is formed by the supply of breathable gas brought by the flexible tube.

7. The respiratory equipment according to claim 1, wherein the pneumatic valve is part of a distributor connected to the gas supply tube and the interface element is configured for engaging with a piston of said distributor.

8. The respiratory equipment according to claim 7, wherein the piston is displaceable along a longitudinal axis between a first position called test position corresponding to the test position of the interface element, a second position called closed-circuit corresponding to the normal storage position of the interface element, and a third position called established circuit corresponding to the removed position of the interface element.

9. The respiratory equipment according to claim 7, wherein the piston is displaceable along a longitudinal axis between a first position called test position corresponding to the test position of the interface element, which also serves as established circuit position corresponding to a removed position of the interface element, and a second position called closed-circuit, corresponding to the normal storage position of the interface element.

10. The respiratory equipment according to claim 7, wherein the position is pushed at least towards the second position, either by an elastic element, or by the breathing gas pressure.

11. The respiratory equipment according to claim 1, wherein the mechanical linkage between the retention element and the interface element is a ball joint linkage.

12. The respiratory equipment according to claim 1, wherein the pneumatic distributor is located in the median zone of one of the housing walls, preferably in the extension of the position of the interface element when it is in position in the retention element.

13. The respiratory equipment according to claim 1, wherein the interface element is connected unremovably on the back bottom part of the harness, preferably by means of a short, flexible link.

14. The respiratory equipment according to claim 7, wherein the flexible link has a length shorter than 10 cm.
